(19) United States
(12) Patent Application Publication
(10) Pub. No.: US 2011/0028034 A1
(43) Pub. Date: Feb. 3, 2011

(54) HOOP MATERIAL, METHOD OF MAKING INNER CONDUCTOR TERMINAL, AND COAXIAL CONNECTOR

(75) Inventor: Taishi Morikawa, Shizuoka (JP)

Correspondence Address: SUGHRUE-265550, 2100 PENNSYLVANIA AVE. NW, WASHINGTON, DC, 20037-3213, US

(73) Assignee: YAZAKI CORPORATION, Tokyo (JP)

(21) Appl. No.: 12/921,842

(22) PCT Filed: Mar. 13, 2009
(86) PCT No.: PCT/JP2009/054956

§ 371 Date: Sep. 10, 2010

(30) Foreign Application Priority Data
Mar. 13, 2008 (JP) 2008-063956

(51) Int. Cl. H01R 13/648; H01R 4/10; H01R 43/16

(52) U.S. Cl. 439/578; 439/877; 29/874

(57) ABSTRACT

An object of the present invention is to provide an electronic part-mounted and insulator-integrated inner conductor terminal which can enhance the productivity and can reduce the cost and also to provide a coaxial connector provided with this inner conductor terminal. A hoop material 41 of the present invention includes a first carrier 42, a second carrier 44 disposed parallel to the first carrier 42 and spaced a predetermined distance therefrom, and a plurality of inner conductor terminals each having a mating side-connecting terminal 14 and a core wire-connecting terminal 15, and the mating side-connecting terminal 14 includes an electrical contact portion 48 connected to the first carrier 42 through a first connection portion 43, and a first lead connection portion 49, and the core wire-connecting terminal 15 includes a core wire press-clamping portion 16 connected to the second carrier 44 through a second connection portion 45, and a second lead connection portion 52, and the first lead connection portion 49 and the second lead connection portion 52 are opposed to each other with a predetermined space formed therebetween.

### TECHNICAL FIELD

The present invention relates to a coaxial connector to be provided at an end of a coaxial cable and also to an inner conductor terminal serving as one component part of this coaxial connector.

### BACKGROUND ART

A technique concerning an inner conductor terminal having an electronic part mounted thereon is disclosed, for example, in the undermentioned Patent Literature 1. The inner conductor terminal is a part to be connected to a core wire of a coaxial cable, and in the undermentioned Patent Literature 1, there is also disclosed a technique of a coaxial connector comprising an inner conductor terminal having an electronic part mounted thereon, an insulator (dielectric member) receiving this inner conductor terminal inserted therein, and an outer conductor terminal which is provided at the outer side of the insulator receiving the inner conductor terminal and is adapted to be connected to a braid of a coaxial cable.

Patent Literature 1: Japanese Patent Publication No. 2004-71208 A

### DISCLOSURE OF INVENTION

### Technical Problem

In the above conventional technique, soldering is required when mounting the electronic part on a body of the inner conductor terminal, and also the number of steps of the overall processing of the inner conductor terminal, including the soldering, is large, and therefore these are the causes of an increased terminal-manufacturing cost. Therefore, the cost of the coaxial connector having such an inner conductor terminal becomes high.

The present invention has been made in view of the above circumstances, and an object thereof is to provide an electronic part-mounted and insulator-integrated inner conductor terminal which can enhance the productivity and can reduce the cost and also to provide a coaxial connector provided with this inner conductor terminal.

### Solution to Problem

A hoop material which has been provided in order to solve the above problem is characterized in that it includes a first carrier, a second carrier disposed parallel to the first carrier and spaced a predetermined distance therefrom, and a plurality of inner conductor terminals each having a mating side-connecting terminal and a core wire-connecting terminal, wherein the mating side-connecting terminal includes an electrical contact portion connected to the first carrier through a first connection portion, and a first lead connection portion, and the core wire-connecting terminal includes a core wire press-clamping portion connected to the second carrier through a second connection portion, and a second lead connection portion, and the first lead connection portion and the second lead connection portion are opposed to each other with a predetermined space formed therebetween.

Preferably, the above hoop material of the present invention is characterized in that each of the first lead connection portion and the second lead connection portion has a pair of upstanding pieces for the fitting connection of a lead of an electronic part thereto.

Preferably, the pair of upstanding pieces are characterized in that they include a first portion of a semi-cylindrical shape, and a pair of opposed second portions of a cross-sectionally S-shape extending continuously respectively from both ends of the first portion, and the first and second lead connection portions each is inserted between the pair of second portions.

A method of making an inner conductor terminal which has been provided in order to solve the above problem is characterized in that it comprises the step of preparing a hoop material includes a first carrier, a second carrier disposed parallel to the first carrier and spaced a predetermined distance therefrom, and a plurality of inner conductor terminals each having a mating side-connecting terminal and a core wire-connecting terminal, wherein the mating side-connecting terminal includes an electrical contact portion connected to the first carrier through a first connection portion, and a first lead connection portion, and the core wire-connecting terminal includes a core wire press-clamping portion connected to the second carrier through a second connection portion, and a second lead connection portion, and the first lead connection portion and the second lead connection portion are opposed to each other with a predetermined space formed therebetween, the step of connecting leads of an electronic part respectively to the first lead connection portion and the second lead connection portion, and the step of moving the hoop material by a predetermined amount, and hoop-molding an insulator in such a manner that the insulator covers the periphery of the electric part connected to the first lead connection portion and the second lead connection portion each time the hoop material is moved, and also cutting at least the first connection portion.

Furthermore, the present invention includes an electronic part-mounted and insulator-integrated inner conductor terminal manufactured by the above inner conductor terminal-making method.

A coaxial cable of the present invention which has been provided in order to solve the above problem is characterized in that it comprises an insulator assembly formed by connecting an inner conductor terminal, manufactured by the above inner conductor terminal-manufacturing method, to a core wire of a coaxial cable, and an outer conductor terminal connected to a braid of the coaxial cable and holding the insulator assembly.

In the present invention having the above features, there is provided the structure in which the insulator is hoop-molded on the body (metallic portion) of the inner conductor terminal having the mating side-connecting terminal and the core wire-connecting terminal, and therefore the electronic part can be contained in that portion which is hoop-molded. Therefore, by manufacturing such a structure, the inner conductor terminal having the electronic part mounted thereon and also having the integrated insulator is formed. After this formation, when the electronic part-mounted and insulator-integrated inner conductor terminal is connected to the core wire of the coaxial cable, the insulator assembly is formed, and when the outer conductor terminal is connected to the braid of the coaxial cable while holding the insulator assembly in the outer conductor terminal, the coaxial connector is formed at the cable end. In the present invention, the electronic part is mounted not by soldering its leads but by the structure in which the lead is inserted between the pair of upstanding pieces and is fittingly connected thereto.

### Advantageous Effects of Invention

In the present invention described above, there is achieved advantages that the productivity can be more enhanced than in the past and that the cost can be reduced Also, in the present invention described above, there is achieved an advantage that the invention can contribute to the enhanced productivity by making the mounting of the electronic part easy.

### BRIEF DESCRIPTION OF DRAWINGS

FIG. 1 is a perspective view showing an electronic part-mounted and insulator-integrated inner conductor terminal of the present invention and one embodiment of a coaxial connector including it.

FIG. 2 is a perspective view of an insulator assembly including the electronic part-mounted and insulator-integrated inner conductor terminal.

FIG. 3 is a perspective view of an outer conductor terminal as seen from an upper open portion-side.

FIG. 4 is a rear view of the outer conductor terminal.

FIG. 5 is a perspective view of the outer conductor terminal as seen from a lower base portion side.

FIG. 6 is a perspective view showing a condition in which the insulator assembly is set in the outer conductor terminal.

FIG. 7 is a perspective view of a hoop material.

FIG. 8 is a perspective view showing a condition immediately before an electronic part is set.

FIG. 9 is a perspective view showing a condition in which the electronic part is set.

FIG. 10 is a perspective view of the electronic part-mounted and insulator-integrated inner conductor terminal immediately after the hoop-molding.

### REFERENCE SIGNS LIST

1 coaxial connector
2 coaxial cable
3 insulator assembly
4 outer conductor terminal
5 electronic part-mounted and insulator-integrated inner conductor terminal
6 core wire
7 insulator
8 metallic tape conductor
9 braid
10 insulative sheath
11 inner conductor terminal body
12 electronic part
13 insulator
14 mating side-connecting terminal
15 core wire-connecting terminal
16 core wire press-clamping portion
17 holding portion
18, 19 flange portion
20, 21 abutting surface
25 joint line
26 braid connecting-purpose press-fastening piece
27 sheath fixing-purpose press-fastening piece
30 upper open portion
31 insulator holding-purpose press-fastening piece
32 side portion
41 hoop material
42 first carrier
43 first connection portion
44 second carrier
45 second connection portion
46 space
47 pair
48 electrical contact portion
49 first lead connection portion
50 lead
51 second lead connection portion
52 tubular portion
53 carrier interconnector

### DESCRIPTION OF EMBODIMENTS

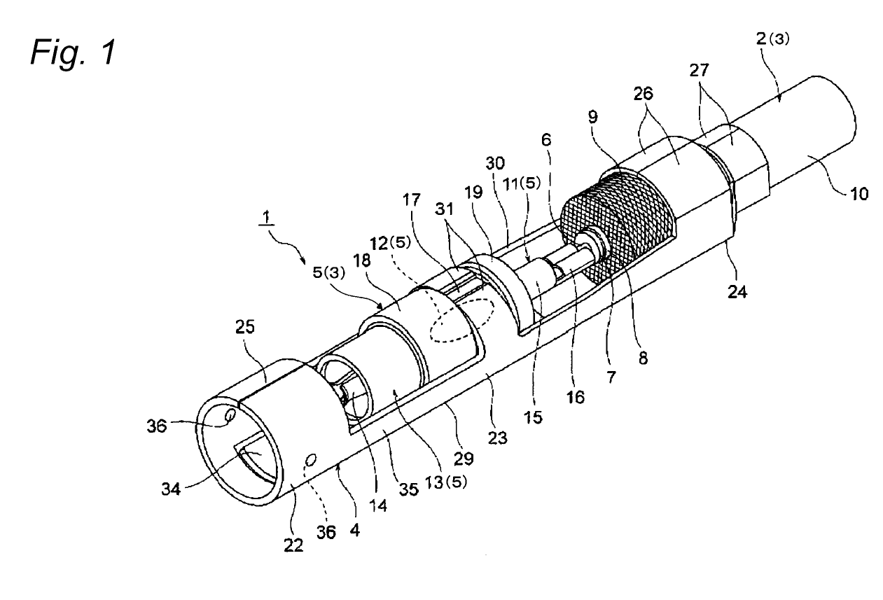

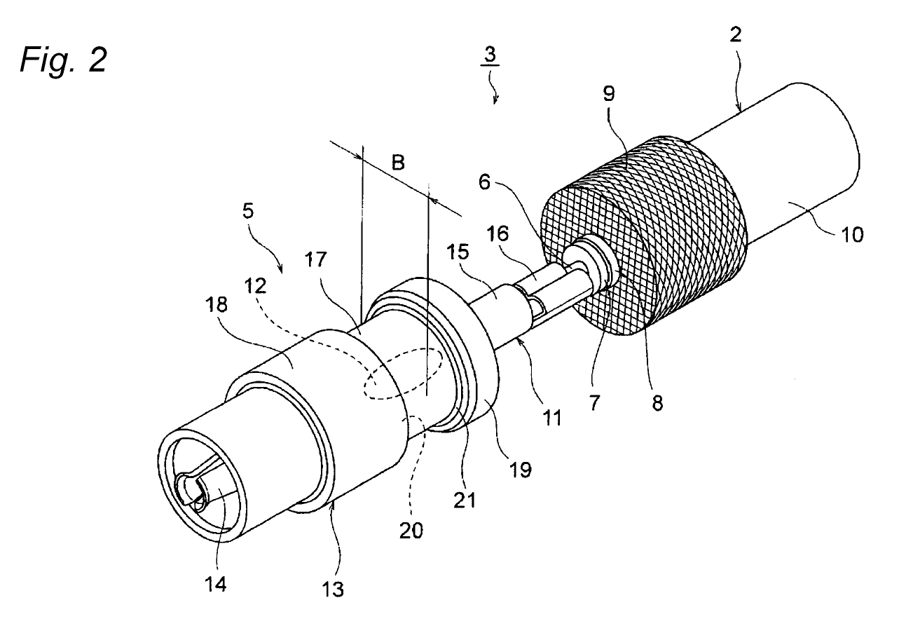

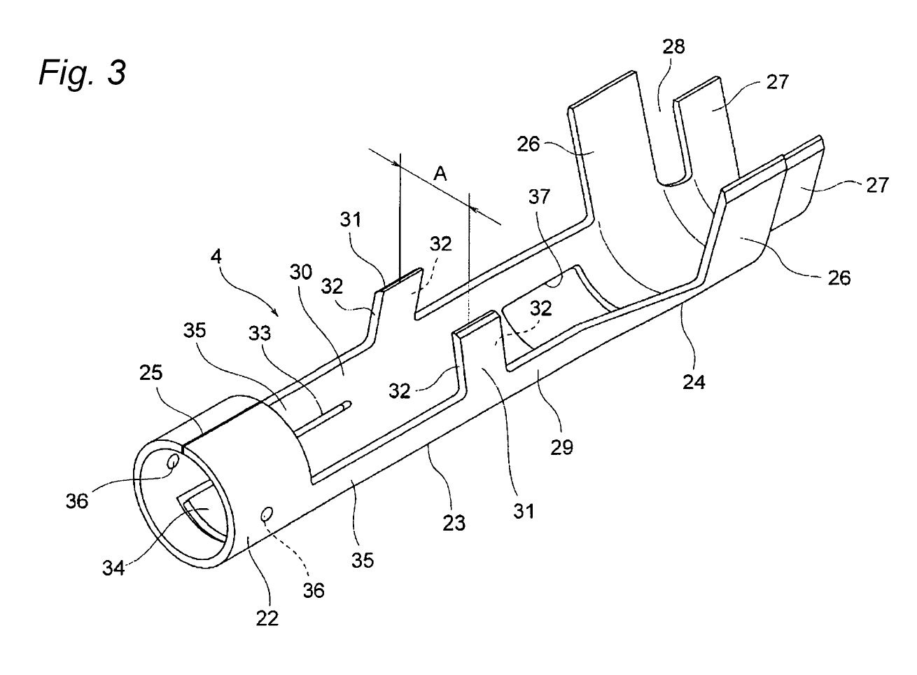

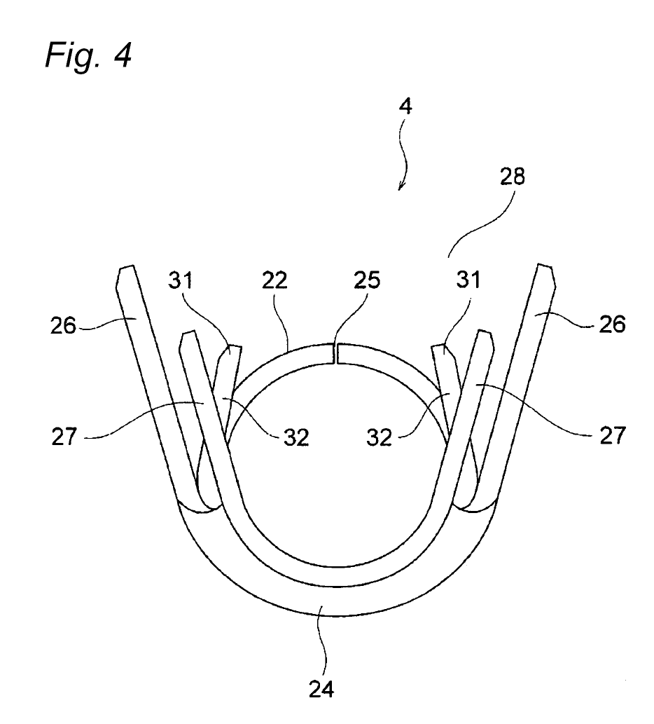

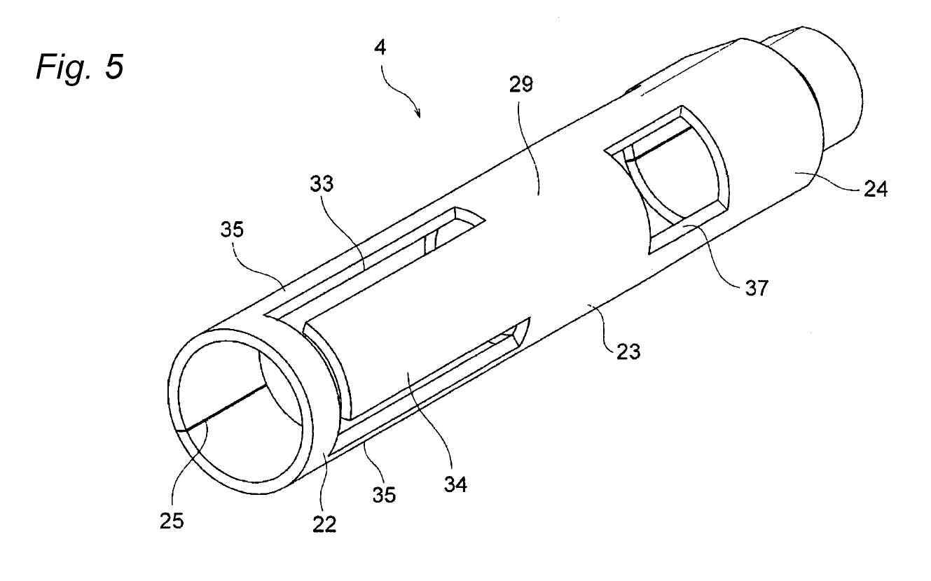

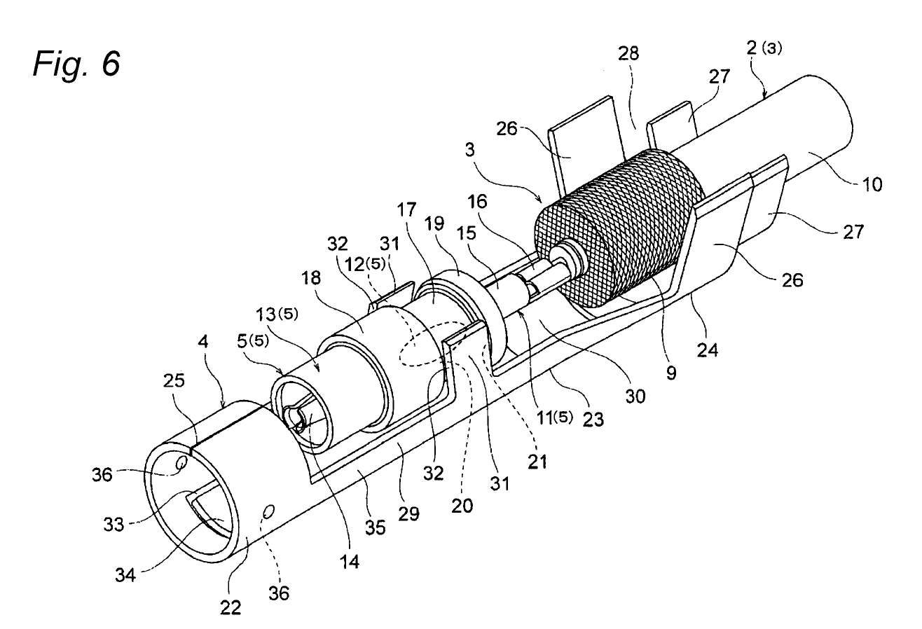

Description will be made below with reference to the drawings. FIG. 1 is a perspective view showing an electronic part-mounted and insulator-integrated inner conductor terminal of the present invention and one embodiment of a coaxial connector including it. FIG. 2 is a perspective view of an insulator assembly including the electronic part-mounted and insulator-integrated inner conductor terminal, FIG. 3 is a perspective view of an outer conductor terminal as seen from an upper open portion-side, FIG. 4 is a rear view of the outer conductor terminal, FIG. 5 is a perspective view of the outer conductor terminal as seen from a lower base portion side, and FIG. 6 is a perspective view showing a condition in which the insulator assembly is set in the outer conductor terminal.

In FIG. 1, the coaxial connector 1 is a connector adapted to be provided at an end of a coaxial cable 2, and comprises the insulator assembly 3, and the outer conductor terminal 4. The insulator assembly 3 is formed by connecting the electronic part-mounted and insulator-integrated inner conductor terminal 5 to the end of the coaxial cable 2. The coaxial connector 1 is formed by connecting and fixing the insulator assembly 3 of the above construction and the outer conductor terminal 4 together. First, each of the component members will be described.

In FIG. 2 and FIG. 3, the insulator assembly 3 is constructed such that it includes the end of the coaxial cable 2. The coaxial cable 2 is already known, and comprises, in outward sequence from the center, a core wire 6 as a center conductor, an insulator 7 as a dielectric member, a metallic tape conductor 8 and a braid 9 as an outer conductor, and an insulative sheath 10 as an outer covering. The coaxial cable 2 is processed such that the core wire 6 is exposed over a predetermined length. The braid 9 is processed into such a condition that it is folded back on the insulative sheath 10 so as to be able to be connected to the outer conductor terminal 4.

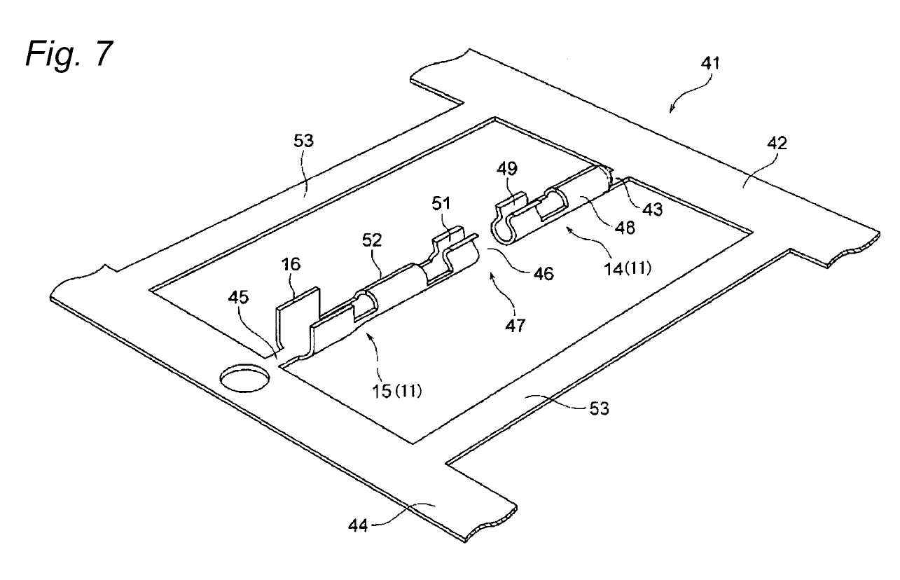

The electronic part-mounted and insulator-integrated inner conductor terminal 5 comprises a metallic inner conductor terminal body 11 having electrical conductivity, an electronic part 12 mounted on this inner conductor terminal body 11, and an insulator 13 which is hoop-molded using an insulative resin material (or potting material) and functions as a dielectric member (A method of producing the electronic part-mounted and insulator-integrated inner conductor terminal 5 will be described later with reference to FIG. 7 to FIG. 10.).

The inner conductor terminal body 11 is formed by two parts which are a mating side-connecting terminal 15 and a core wire-connecting terminal 14. A core wire press-clamping portion 16 comprising a pair of press-fastening pieces are formed at the core wire-connecting terminal 15. The core wire press-clamping portion 16 can connect and fix the core wire 6 of the coaxial cable 2 thereto by press-fastening. The electronic part 12 is mounted between the mating side-connecting terminal 14 and the core wire-connecting terminal 15. Although described later, the electronic part 12 has leads, and is adapted to be mounted not by soldering its leads but by a structure in which the lead is inserted between a pair of upstanding pieces and is fittingly connected thereto. It is preferred that the upstanding pieces have elasticity. For example, a capacitor is given as one example of the electronic part 12.

The insulator 13 integrates the inner conductor terminal body 11 and the electronic part 12 with each other in a manner to cover the periphery of the electronic part 12, and is formed into a substantially cylindrical shape. Also, the insulator is formed into such a shape that it intervenes between the outer conductor terminal 4 and the inner conductor terminal body 11 and functions as a dielectric member. A holding portion 17 related to the fixing to the outer conductor terminal 4 is formed at an outer peripheral surface of the insulator 13. Further, annular flange portions 18, 19 larger in diameter than the holding portion 17 are formed on the outer peripheral surface and are disposed respectively at the front and rear sides of the holding portion 17. Abutting surfaces 20, 21 are formed respectively at the flange portions 18, 19 because of a step formed between them and the holding portion 17.

In FIG. 1, FIG. 3, FIG. 4 and FIG. 5, the outer conductor terminal 4 is formed into a substantially cylindrical shape by press-working a metal sheet having electrical conductivity. Here, when reference numeral 22 denotes a front portion of the outer conductor terminal 4, reference numeral 23 denotes an intermediate portion, and reference numeral 24 denotes a rear portion (see FIG. 3), the front portion 22 and its vicinity are formed as a portion for connection to a mating connector (not shown). The front portion 22 is formed into a cylindrical (annular) shape. A joint line 25 produced by the above press-working is formed at the upper side of the front portion 22.

A pair of braid connecting-purpose press-fastening pieces 26 and a pair of sheath fixing-purpose press-fastening pieces 27 are formed at the rear portion 24 of the outer conductor terminal 4. The pair of braid connecting-purpose press-fastening pieces 26 and the sheath fixing-purpose press-fastening pieces 27 are arranged to be juxtaposed to each other in the forward-rearward direction. Also, the pair of braid connecting-purpose press-fastening pieces 26, as well as the pair of sheath fixing-purpose press-fastening pieces 27, are formed into such a shape that their distal ends are open gradually outwardly. The pair of braid connecting-purpose press-fastening pieces 26 are so formed as to be able to connect and fix the braid 9 of the coaxial cable 2 thereto by press-fastening, and the pair of sheath fixing-purpose press-fastening pieces 27 are so formed as to be able to fix the insulative sheath 10. The pair of braid connecting-purpose press-fastening pieces 26 are formed to project longer than the pair of sheath fixing-purpose press-fastening pieces 27. The pair of braid connecting-purpose press-fastening pieces 26 and the pair of sheath fixing-purpose press-fastening pieces 27 are formed such that that portion designated by reference numeral 28 is in an open condition before the press-fastening (see FIG. 4).

A lower base portion 29 of a semi-cylindrical shape which is continuous with the front portion 22 and is also continuous with the pair of braid connecting-purpose press-fastening pieces 26 of the rear portion 24 is formed at the intermediate portion 23 of the outer conductor terminal 4. Also, an upper open portion 30 is formed at the intermediate portion 23 in a manner to open the whole of the upper side of this intermediate portion 23. A pair of insulator holding-purpose press-fastening pieces 31 for holding the insulator 13 of the insulator assembly 3 by press-fastening are formed respectively at opening edges of the upper open portion 30. The pair of insulator holding-purpose press-fastening pieces 31 are disposed and formed at a middle position in the forward-rearward direction. The pair of insulator holding-purpose press-fastening pieces 31 are formed into an inwardly-inclined shape so that a gap A between their distal ends conforms to a diameter B of the holding portion 17 of the insulator assembly 3 (for example, A≈B) and that side portions 32 can abut against the abutting surfaces 20, 21 of the flange portions 18, 19 of the insulator assembly 3.

A plurality of spring structural portions for connection to the mating connector (not shown) are formed at the lower base portion 29. The spring structural portions are disposed and formed forwardly of the position of the pair of insulator holding-purpose press-fastening pieces 31. In this embodiment, they are disposed and formed to extend over the front portion 22. The spring structural portions comprise a first contact spring 34 provided by forming a U-shaped slit 33 (see FIG. 5) in the lower base portion 29, and a pair of second contact springs 35 which can be opened outwardly at both sides of this first contact spring 34 because of the provision of the joint line 25 in the front portion 22 (This is one example.). A contact indent 36 is formed at the second contact spring 35. Taking an anti-noise property into consideration, the spring structural portions have a multi-contact structure with respect to the connection to the mating connector (not shown). Incidentally, by forming the spring structural portions of this embodiment into the illustrated shapes, they have such a structure that a compact design can be achieved.

Reference numeral 37 in the lower base portion 29 designates a retaining hole for being retained by a lance or the like. The retaining hole 37 functions also as a portion for avoiding the contact with the core wire-connecting terminal 15 of the insulator assembly 3.

Next, one example of a method of assembling the coaxial connector 1 will be described based on the above construction and structure. The method of assembling the coaxial connector 1 comprises a first step of forming the insulator assembly 3, a second step of setting the insulator assembly 3 in the outer conductor terminal 4 through the upper open portion 30 of the outer conductor terminal 4 from a direction perpendicular to the axis of the terminal, and a third step of holding the insulator 13 of the insulator assembly 3 by press-fastening the pair of insulator holding-purpose press-fastening pieces 31 and effecting the connection and fixing of the insulator assembly 3 to the coaxial cable 2 by press-fastening the pair of braid connecting-purpose press-fastening pieces 26 and the pair of sheath fixing-purpose press-fastening pieces 27. The assembling method will be described below in a little more detail.

In FIG. 2, the electronic part-mounted and insulator-integrated inner conductor terminal 5 is connected to the end of the coaxial cable 2 to form the insulator assembly 3 (A method of producing the electronic part-mounted and insulator-integrated inner conductor terminal 5 will be described later.), and then when this insulator assembly 3 is merely lowered from the upper side of the outer conductor terminal 4 through the upper open portion 30 and is set in the outer conductor terminal 4, a set condition as shown in FIG. 6 is formed. At this time, the setting of the insulator assembly 3 is made possible only at a predetermined position since the diameter B (see FIG. 2) of the holding portion 17 of the insulator assembly 3 and the distal end gap A of the pair of insulator holding-purpose press-fastening pieces 31 of the outer conductor terminal 4 are adjusted to substantially the same dimension.

Incidentally, in the set condition as shown in FIG. 6, the movement of the insulator assembly 3 in the forward-rearward direction is restrained by the pair of insulator holding-purpose press-fastening pieces 31 and the flange portions 18, 19, and therefore the set position is made stable. Specifically, the forward-rearward movement is restrained by the abutting engagement of the side portions 32 of the holding portion 17 with the abutting surfaces 20, 21, and therefore the set position of the insulator assembly 3 is made stable.

When the pair of insulator holding-purpose press-fastening pieces 31 are press-fastened after the insulator assembly 3 is set in the outer conductor terminal 4, the holding portion 17 of the insulator 13 of the insulator assembly 3 is held. Also, when the pair of sheath fixing-purpose press-fastening pieces 27 are press-fastened, the insulative sheath 10 of the coaxial cable 2 of the insulator assembly 3 is held. The insulator assembly 3 is held at these two portions, so that the fixing thereof to the outer conductor terminal 4 is completed. Further, when the pair of braid connecting-purpose press-fastening pieces 26 are press-fastened, the braid 9 of the coaxial cable 2 of the insulator assembly 3 is contacted with the braid connecting-purpose press-fastening pieces 26, so that its connection to the outer conductor terminal 4 is completed. With the foregoing, the assembling is completed, and the coaxial connector 1 as shown in FIG. 1 is formed.

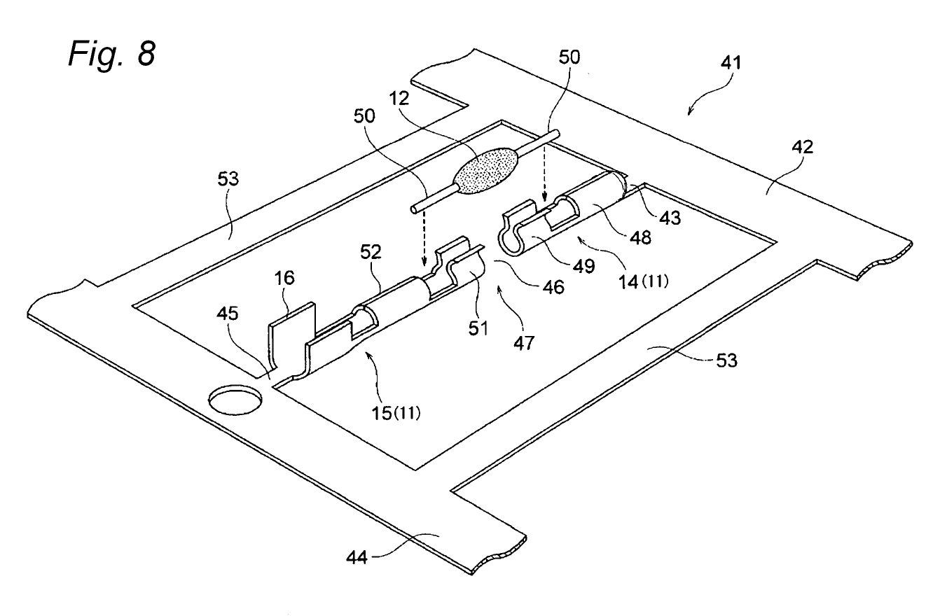

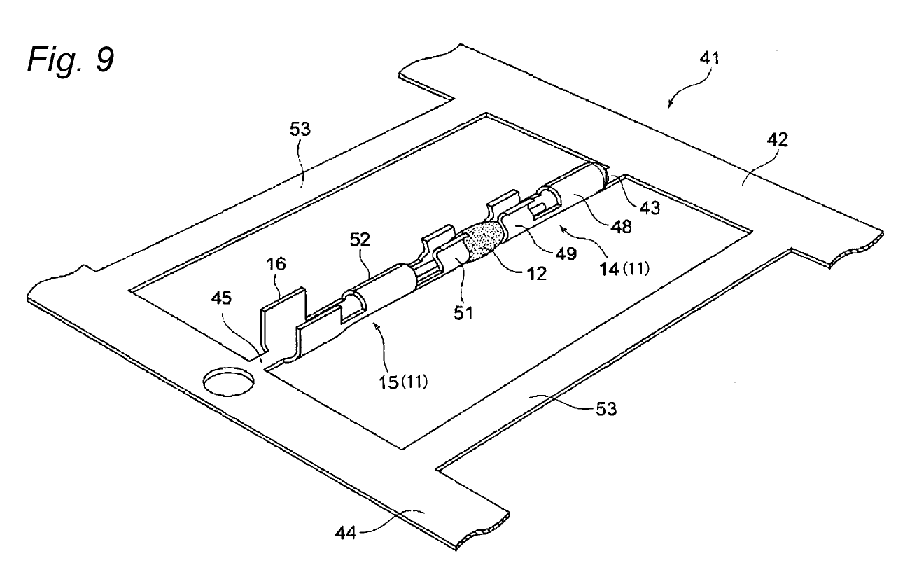

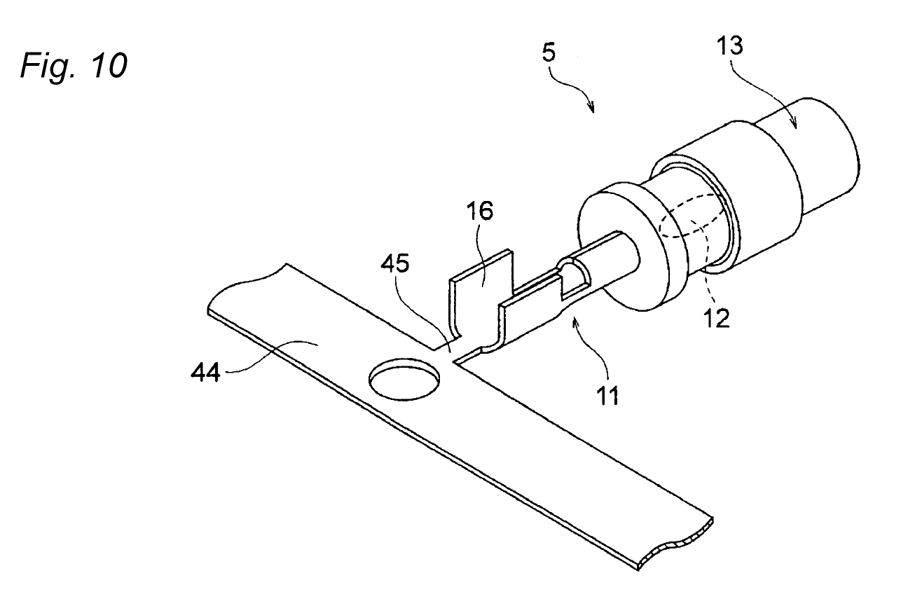

Next, the method of manufacturing the above electronic part-mounted and insulator-integrated inner conductor terminal 5 will be described with reference to FIG. 7 to FIG. 10. FIG. 7 is a perspective view of a hoop material, FIG. 8 is a perspective view showing a condition immediately before the electronic part is set, FIG. 9 is a perspective view showing a condition in which the electronic part is set, and FIG. 10 is a perspective view of the electronic part-mounted and insulator-integrated inner conductor terminal immediately after the hoop-molding.

In FIG. 7, the mating side-connecting terminal 14 is integrally formed at a first carrier 42 of the band-like hoop material 41, composed of a metallic material having electrical conductivity, through a first connection portion 43. Also, the core wire-connecting terminal 15 is integrally formed through a second connection portion 45 at a second carrier 44 disposed parallel to the first carrier 42 and spaced a predetermined distance therefrom. The mating side-connecting terminal 14 is formed to extend in a direction perpendicular to the first carrier 42. The core wire-connecting terminal 15 is formed to extend in a direction perpendicular to the second carrier 44. The mating side-connecting terminal 14 and the core wire-connecting terminal 15 are arranged in opposed relation to each other such that a space 46 is formed therebetween. The mating side-connecting terminal 14 and the core wire-connecting terminal 15 make a pair 47. The space 46 is determined according to the size of the electronic part 12 (see FIG. 8).

The mating side-connecting terminal 14 has an electrical contact portion 48 formed at one end thereof (Although the electrical contact portion 48 is formed into a pin-like shape as shown in the drawings, it is, of course, not limited to this shape and may have such a shape as shown in FIG. 2.). A first lead connection portion 49 for connection to the lead of the electronic part is formed at the other end of the mating side-connecting terminal 14. The first lead connection portion 49 is formed into such a shape that it has a pair of upstanding pieces between which the lead 50 (see FIG. 8) of the electronic part 12 can be inserted to be fittingly connected thereto. The electrical contact portion 48 is formed to be continuous with the first connection portion 43.

The core wire-connecting terminal 15 has the core wire press-clamping portion 16 formed at one end thereof. Also, a second lead connection portion 51 for connection to the lead of the electronic part is formed at the other end of the core wire-connecting terminal 15. The second lead connection portion 51 is formed into the same shape as the above first lead connection portion 49. A tubular portion 52 is formed between the core wire press-clamping portion 16 and the second lead connection portion 51. The core wire press-clamping portion 16 is formed into such a shape that it can press-fasten the core wire 6 of the coaxial cable 2. The core wire press-clamping portion 16 is formed to be continuous with the second connection portion 45.

A plurality of carrier interconnectors 53 interconnecting the first carrier 42 and the second carrier 44 are formed at the hoop material 41. The pair made by the mating side-connecting terminal 14 and the core wire-connecting terminal 15 is disposed parallel to the carrier interconnectors 53. Although not shown, there exist a plurality of pairs 47 each made by the mating side-connecting terminal 14 and the core wire-connecting terminal 15, and these pairs are arranged alternately with the carrier interconnectors 53. The hoop material 41 is adapted to be moved in its longitudinal direction by a predetermined amount each time.

In FIG. 8 and FIG. 9, the electric part 12 is connected to the first lead connection portion 49 and the second lead connection portion 52 through the leads 50, and thereafter when the hoop-molding is effected in a manner to cover the periphery of the electronic part 12, the insulator 13 is formed on the periphery of the electronic part 12 as shown in FIG. 10, so that the electronic part-mounted and insulator-integrated inner conductor terminal 5 is formed. In this embodiment, the first connection portion 43 and the carrier interconnectors 53 disposed at both sides thereof are cut off simultaneously with the hoop-molding. When the core wire 6 of the coaxial cable 2 is set in the core wire press-clamping portion 16 of the electronic part-mounted and insulator-integrated inner conductor terminal 5 while cutting off the second connection portion 45, and it is press-fastened, the insulator assembly 3 as shown in FIG. 2 is formed.

As described above with reference to FIG. 1 to FIG. 10, in the present invention, there can be provided the inner conductor terminal having the electronic part mounted thereon and also having the integrated insulator, that is, the electronic part-mounted and insulator-integrated inner conductor terminal 5. Also, there can be provided the coaxial connector 1 including the electronic part-mounted and insulator-integrated inner conductor terminal 5. As will be appreciated from the above description, in the electronic part-mounted and insulator-integrated inner conductor terminal 5 and the coaxial connector 1, soldering for the electronic part as in the past is not effected, and as a result the inner conductor terminal and the coaxial connector can be easily formed, and therefore there is achieved an advantage that the productivity can be more enhanced than in the past. Also, there is achieved an advantage that the cost can be reduced.

The present invention can, of course, be carried out in variously-changed ways in so far as the subject matter of the present invention is not changed.

Here, other features of the coaxial connector 1 will be enumerated.

(1) A coaxial connector characterized in that it comprises an insulator assembly including an electronic part-mounted and insulator-integrated inner conductor terminal (having an electronic part mounted thereon and also having an integrated insulator) and a coaxial cable, and a substantially-tubular outer conductor terminal which holds the insulator and has a pair of braid connection-purpose press-fastening pieces for being connected to a braid of the coaxial cable, wherein the outer conductor terminal has an upper open portion which is disposed at an open side of the braid connecting-purpose press-fastening pieces before the press-fastening thereof and also forwardly of the position of the braid connecting-purpose press-fastening pieces and is provided for the purpose of setting the insulator assembly from the open side, and also has a pair of insulator holding-purpose press-fastening pieces formed respectively at opening edges of the upper open portion so as to hold the insulator.

(2) In a coaxial connector as set forth in the above (1), the coaxial connector is characterized in that the insulator has annular flange portions formed respectively at the front and rear sides of a holding portion which is to be held by the pair of insulator holding-purpose press-fastening pieces and that the pair of insulator holding-purpose press-fastening pieces are formed into an inwardly-inclined shape so that a gap between their distal ends conforms to a diameter of the holding portion and also that side portions thereof can abut against the front and rear flange portions.

(3) In a coaxial connector as set forth in the above (1) or (2), the coaxial connector is characterized in that the outer conductor terminal has a plurality of spring structural portions for connection to a mating connector which spring structural portions are formed at a lower base portion disposed at that side opposite from the upper open portion, and are disposed forwardly of the position of the pair of insulator holding-purpose press-fastening pieces.

(4) A method of assembling a coaxial connector characterized in that the method comprises a first step of connecting an electronic part-mounted and insulator-integrated inner conductor terminal (having an electronic part mounted thereon and also having an integrated insulator) and a core wire of a coaxial cable together to thereby form an insulator assembly, a second step of setting the insulator assembly through an upper open portion of a substantially-tubular outer conductor terminal from a direction perpendicular to a terminal axis, and a third step of holding the insulator of the insulator assembly by press-fastening a pair of insulator holding-purpose press-fastening pieces formed respectively at opening edges of the upper open portion, and effecting the connection of the insulator assembly to a braid of the coaxial cable by press-fastening a pair of braid connecting-purpose press-fastening pieces disposed rearwardly of the upper open portion.

According to the above features (1) to (4), the setting of the insulator assembly relative to the outer conductor terminal is a simple and easily-seen operation in which it is merely lowered from the upper side, and besides after the setting, the assembling is completed merely by the press-fastening operation, and therefore there is achieved an advantage that the operation efficiency is very good.

The above features (1) to (4) are effective in solving the following problem arising in the disclosed technique of Patent Literature 1 mentioned in Section “Background Art”. The problem is that the operation for inserting the insulator relative to the outer conductor terminal and the operation for inserting the inner conductor terminal relative to the insulator attached to the outer conductor terminal are effected along the axial direction of the outer conductor terminal, and therefore particularly in the case of the small-size parts, it is difficult to see, and also it is difficult to know the amount of insertion, and therefore there is a problem that operation efficiency is affected.

The present invention can, of course, be carried out in variously-changed ways in so far as the subject matter of the present invention is not changed. Although the present invention has been described in detail with respect to the specified embodiment, it will be obvious to those skilled in the art that various changes and modifications can be added without departing from the spirits and scope or intended scope of the present invention.

The present invention is based on Japanese Patent Application (Patent Application No. 2008-063956) filed on Mar. 13, 2008, and its contents are incorporated herein by reference.

### INDUSTRIAL APPLICABILITY

In the present invention, the productivity can be more enhanced than in the past, and the cost can be reduced. Also, the present invention can contribute to the enhanced productivity by making the mounting of the electronic part easy.

1. A hoop material characterized in that the hoop material includes:
a first carrier;
a second carrier disposed parallel to the first carrier and spaced a predetermined distance from the first carrier; and
a plurality of inner conductor terminals each having a mating side-connecting terminal and a core wire-connecting terminal,
wherein the mating side-connecting terminal includes an electrical contact portion connected to the first carrier through a first connection portion, and a first lead connection portion,
wherein the core wire-connecting terminal includes a core wire press-clamping portion connected to the second carrier through a second connection portion, and a second lead connection portion, and
wherein the first lead connection portion and the second lead connection portion are opposed to each other with a predetermined space formed therebetween.

2. The hoop material as set forth in claim 1, characterized in that, each of the first lead connection portion and the second lead connection portion has a pair of upstanding pieces with which a lead of an electronic part is fitted.

3. The hoop material as set forth in claim 2, characterized in that, the upstanding pieces include a first portion having a semi-cylindrical shape, and a pair of opposed second portions having a cross-sectionally S-shape and continuously extending from both ends of the first portion respectively; and
the lead of the electronic part is inserted between the pair of second portions.

4. A method of making an inner conductor terminal formed in such a condition as be able to be connected to an end of a coaxial cable, characterized in that the method comprises:
a step of preparing a hoop material including a first carrier, a second carrier disposed parallel to the first carrier and spaced a predetermined distance therefrom, and a plurality of inner conductor terminals each having a mating side-connecting terminal and a core wire-connecting terminal, wherein the mating side-connecting terminal includes an electrical contact portion connected to the first carrier through a first connection portion, and a first lead connection portion, and the core wire-connecting terminal includes a core wire press-clamping portion connected to the second carrier through a second connection portion, and a second lead connection portion, and the first lead connection portion and the second lead connection portion are opposed to each other with a predetermined space formed therebetween;
a step of connecting leads of an electronic part respectively to the first lead connection portion and the second lead connection portion; and
a step of moving the hoop material by a predetermined amount, and hoop-molding an insulator in such a manner that the insulator covers a periphery of the electric part connected to the first lead connection portion and the second lead connection portion each time the hoop material is moved, and also cutting at least the first connection portion.

5. An inner conductor terminal characterized in that the inner conductor terminal is made by an inner conductor terminal-making method as set forth in claim 4.

6. A coaxial connector characterized in that the coaxial connector comprises:
an insulator assembly formed by connecting an inner conductor terminal as set forth in claim 5 to a core wire of a coaxial cable; and
an outer conductor terminal connected to a braid of the coaxial cable and holding the insulator assembly.
